(19) United States
(12) Patent Application Publication
(10) Pub. No.: US 2013/0089591 A1
(43) Pub. Date: Apr. 11, 2013

(54) Compositions

(71) Applicants: Claire Vautrin, Pinsot (FR); Cedric Geffroy, Buxerolles (FR)

(72) Inventors: Claire Vautrin, Pinsot (FR); Cedric Geffroy, Buxerolles (FR)

(73) Assignee: Givaudan SA, Vernier (CH)

(21) Appl. No.: 13/699,472

(22) PCT Filed: Jun. 27, 2011
(86) PCT No.: PCT/EP2011/060736

§ 371 Date: Nov. 21, 2012

(30) Foreign Application Priority Data
Jun. 25, 2010 (EP) 10290345.7

(51) Int. Cl. C11B 9/00

(52) U.S. Cl. CPC C11B 9/0003
USPC 424/401; 512/4; 510/101; 264/4.7

(57) ABSTRACT

Polyurea and polyamide capsules encapsulating fragrance oils, which oils contain precursors of fragrant aldehydes that are adapted to release the aldehydes under activating conditions.

The present invention is concerned with capsules containing odourant oils.

It is known to encapsulate odourant formulations. Odourant formulations may be encapsulated for many reasons. An odourant formulation may be encapsulated with the purpose of influencing its hedonic profile by altering the rate of evaporation of specific odourant ingredients contained in the formulation. An odourant formulation may also be encapsulated with the purpose of improving its performance by extending or modifying its rate of release, or to stablise it or certain of its ingredients towards aggressive media that may be contained in end use applications such as fabric softeners or the like.

Given that encapsulation can add so much to a fragrance or flavour formulation in terms of hedonics and performance, a great deal of research has gone into the development of encapsulation technology to create optimal vehicles for the delivery of odourant formulations.

One such encapsulation technology is based on aminoplast resins formed from melamine-formaldehyde polymers. Aminoplast technology can be employed in all manner of odourant-delivery applications. However, one drawback relating to the use of melamine-formaldehyde polymers is that they can contain residual traces of formaldehyde. Whereas the amounts may be so small as to be practically without significance, nevertheless it would be desirable to have highly performing capsules that do not contain traces of formaldehyde.

Polyurea and polyamide capsules are highly performing and may be employed in consumer applications as alternatives to melamine formaldehyde. They show excellent odourant retention and are frangible when subjected to frictional forces. Furthermore, they are relatively straightforward to produce by a polyaddition reaction between an amine and a co-reactant, respectively an isocyanate, an acyl chloride or an acid anhydride, under conditions well known in the art. As such, they may be used in similar applications as melamine-formaldehyde capsules.

The applicant was therefore surprised to find that when forming polyurea or polyamide capsules containing odourant oils, it was often observed that the capsules formed aggregates and in some cases the aggregation phenomenon was so extensive that it even led to caking. Aggregation is at the very least aesthetically undesirable and at worst can lead to manufacturing problems and poor capsule performance and so should be avoided as much as possible.

There remains a need to provide capsules consisting of a core containing an odourant oil and a shell surrounding said core, the shell being formed by a process of polyaddition of an amine and a co-reactant, during which polyaddition reaction the aggregation phenomenon is eliminated or substantially reduced.

Applicant has now found that one can provide such capsules and avoid or substantially reduce the problem of aggregation.

The invention provides in a first aspect a capsule comprising an odourant oil core surrounded by polymeric capsule wall, the capsule wall being formed of a polymer containing recurring nitrogen to carbonyl carbon bonds wherein the oil core contains an aldehyde precursor.

The aldehyde precursor (hereinafter “precursor”), is a compound, that is essentially a derivative of an odoriferous aldehyde compound useful as a perfume ingredient or as a flavour ingredient. The odoriferous aldehyde is an aldehyde that a person skilled in the perfumery art would select from its palette of ingredients to impart to a fragrance a desirable note or odour impression. The precursors' aldehyde functional groups are protected with suitable protecting groups. Upon activating conditions, for example under hydrolysing conditions, the protecting groups are removed to liberate the odoriferous aldehyde.

The precursors may be in the form of acetals or hemi-acetals of a corresponding odoriferous aldehyde. Alternatively, the precursor may be any of those heterocyclic aldehyde-releasing precursors described in patent application WO0072816 including oxazolidines, tetrahydro-1,3-oxazines, thiazolidines or tetrahydro-1,3-thiazines, which application is hereby incorporated by reference.

Particular precursors include those compounds produced by the reaction of an odoriferous aldehyde with a beta-keto ester, for example allyl acetoacetate, methyl acetoacetate, ethyl acetoacetate acetoacetic n-propyl ester, ethyl propionyl acetate, diallyl malonate, or diethyl, dipropyl or dibutyl malonates.

Other useful precursors include those formed by the reaction of an aldehyde with an amine (i.e. Schiff bases of fragrant aldehydes) such as aurantiol, verdantiol, aubepine methyl anthranilate, octylamine, naphthylamine, benzaldehyde methyl anthranilate and cetonial methyl anthranilate.

Particular precursors include those compounds produced by the reaction of an odoriferous aldehyde with an amine, for example methyl anthranylate, octylamine or naphthylamine.

Precursors of odoriferous aldehydes can be made according to synthetic procedures well known in the art and it is not necessary to discuss this aspect in great detail here.

As an example, precursors of odoriferous aldehydes and beta di-keto esters such as ethyl acetoacetate or diethyl malonate may be formed under Knoevenagel conditions, whereby the beta di-keto ester is reacted with a catalyst, e.g. piperidine to form an enol intermediate, which in amounts of slight stoichiometric excess can then react with the odoriferous aldehyde to form the precursor.

Knoevenagel reaction conditions are well known in the art. The reversible nature of this reaction means that the odourant aldehyde may be released under activating conditions, e.g. under hydrolysing conditions. Depending on the nature of the capsule, these activating conditions may be promoted inside the capsule such that the capsule permits a slow emanation of odour characteristic of fragrant aldehydes. Alternatively, the conditions may be activated when the capsules are placed into a particular environment, such as a washing medium. Still further, the conditions may only be activated when the capsules are broken under conditions of mechanical or thermal stress. The skilled person will appreciate that the odoriferous aldehyde may be released in many different ways and at different rates. It is preferred however, that the aldehyde functionality should remain protected in the form of its precursor to the greatest extent possible during capsule formation. In this regard, it is preferred that any oil to be encapsulated according to the present invention contains substantially no fragrance ingredients having free aldehyde functionality.

By “substantially no fragrance ingredients having free aldehyde functionality” is meant that insofar as any aldehyde ingredients are found in the oil before or during encapsulation, they are only found in relatively small amounts, for example less than 1% by weight based on the weight of the oil, more particularly less than 0.1%, still more particularly less than 0.01% by weight of the oil, e.g. 0.01% to 0%.

The aldehyde may be any aldehyde useful in perfumery or as a flavourant. The skilled person in the art of perfumery has available to it a palette of ingredients containing aldehyde functionality, and these ingredients are contemplated in the present invention as representing odoriferous aldehydes. The aldehyde may be an aliphatic aldehyde, a cycloaliphatic aldehyde, and acyclic terpene aldehyde, a cyclic terpene aldehyde, an aromatic aldehyde or a phenol aldehyde.

The aldehydes useful in the present invention can be one or more of, but not limited to, the following group of aldehydes: phenylacetaldehyde, p-methyl phenylacetaldehyde, p-isopropyl phenylacetaldehyde, methylnonyl acetaldehyde, phenylpropanal, 3-(4-t-butylphenyl)-2-methyl propanal, 3-(4-t-butylphenyl)-propanal, 3-(4-methoxyphenyl)-2-methylpropanal, 3-(4-isopropylphenyl)-2-methylpropanal, 3-(3,4-methylenedioxyphenyl)-2-methylpropanal, 3-(4-ethylphenyl)-2,2-dimethylpropanal, phenylbutanal, 3-methyl-5-phenylpentanal, hexanal, trans-2-hexenal, cis-hex-3-enal, heptanal, cis-4-heptenal, 2-ethyl-2-heptenal, 2,6-dimethyl-5-heptenal (melonal), 2,6-dimethylpropanal, 2,4-heptadienal, octanal, 2-octenal, 3,7-dimethyloctanal, 3,7-dimethyl-2,6-octadien-1-al, 3,7-dimethyl-1,6-octadien-3-al, 3,7-dimethyl-6-octenal, 3,7-dimethyl-7-hydroxyoctan-1-al, nonanal, 6-nonenal, 2,4-nonadienal, 2,6-nonadienal, decanal, 2-methyl decanal, 4-decenal, 9-decenal, 2,4-decadienal, undecanal, 2-methyldecanal, 2-methylundecanal, 2,6,10-trimethyl-9-undecenal, undec-10-enyl aldehyde, undec-8-enanal, dodecanal, tridecanal, tetradecanal, anisaldehyde, bourgenonal, cinnamic aldehyde, [alpha]-amylcinnam-aldehyde, [alpha]-hexyl cinnamaldehyde, methoxy cinnamaldehyde, citronellal, hydroxy-citronellal, isocyclocitral, citronellyl oxyacet-aldehyde, cortexaldehyde, cumminic aldehyde, cyclamem aldehyde, florhydral, heliotropin, hydrotropic aldehyde, lilial, vanillin, ethyl vanillin, benzaldehyde, p-methyl benzaldehyde, 3,4-dimethoxybenzaldehyde, 3- and 4-(4-hydroxy-4-methyl-pentyl)-3-cyclohexene-1-caroxaldehyde, 2,4-dimethyl-3-cyclohexene-1-carboxaldehyde, 1-methyl-3-4-methylpentyl-3-cyclohexencarboxaldehyde, and p-methylphenoxyacetaldehyde.

After extensive examination of the aggregation phenomenon, the applicant discovered that odoriferous aldehydes were reacting with the amine used in the encapsulation process, which led to poor capsule formation and aggregation. Applicant found that by converting these aldehydes into aldehyde precursors upstream of the encapsulation step led to a more robust capsule-forming process and reduced aggregation.

The extent or severity of aggregation depends on a number of factors including the reactivity of the aldehyde towards the amine employed in the capsule-forming process as well as the solubility of the aldehyde in aqueous media. As the capsule wall forming process is an interfacial process and the amines used are substantially contained in the aqueous phase, the extent to which an aldehyde will partition into the aqueous phase, may affect its reactivity towards the amine.

Linear aldehydes, i.e. those aldehydes having no substituents at the positions alpha or beta to the aldehyde carbonyl group are relatively reactive and if they are not effectively protected in their precursor form they are likely to cause significant agglomeration problems. Aldehydes containing substituents at the position beta to the aldehyde carbonyl group are somewhat less reactive as are those containing substituents at the position alpha to the carbonyl group, although it is still preferred if even these less reactive aldehydes are protected in the form of precursors.

For the reason mentioned above already, particular attention should also be given to any of these aldehydes that are highly water soluble and tend to partition into the aqueous phase, as they will be more intimately in contact with the amine and therefore far more likely to be reactive towards the amine.

It is within the purview of the skilled person in the art to select an appropriate precursor form for an aldehyde taking into account such factors as the solubility of the aldehyde, its chemical structure and its reactivity with amines.

In another aspect of the invention there is provided a capsule comprising an odourant oil core surrounded by polymeric capsule wall, the capsule wall being formed of a polymer containing recurring nitrogen to carbonyl carbon bonds wherein the oil core contains an aldehyde precursor, wherein the precursor is a precursor of an aldehyde having no substituents at the carbon atoms alpha or beta to the aldehyde carbonyl carbon atom.

In a particular aspect of the present invention there is provided a capsule comprising an odourant oil core surrounded by polymeric capsule wall, the capsule wall being formed of a polymer containing recurring nitrogen to carbonyl carbon bonds wherein the oil core contains perfume ingredients containing free aldehyde functionality and an aldehyde precursor, wherein the precursor is a precursor of a different aldehyde to the aforementioned aldehyde, and which has no substituents at the carbon atoms alpha or beta to the aldehyde carbonyl carbon atom.

In a more particular aspect of the invention there is provided a capsule as described in the preceding paragraph, wherein the perfume ingredient having free aldehyde functionality is substituted on a carbon atom that is alpha or beta to the aldehyde carbonyl carbon atom.

The invention provides in another of its aspects a method of encapsulating an oil in a capsule as hereinabove defined, the method comprising the step of converting any aldehyde-containing oil core ingredients into a precursor therefor, prior to encapsulation.

In a more particular aspect of the invention, there is provided a method of encapsulating an oil, in a capsule as hereinabove defined, the method comprising the step of identifying those ingredients of the oil core ingredients that contain aldehyde functionality, and of those ingredients, converting those having no substituents at the carbon atoms alpha or beta to the aldehyde carbonyl carbon atom into the corresponding precursor prior to encapsulation.

The invention provides in another of its aspects the use of a precursor as hereinabove described to reduce or eliminate aggregation of capsules made according to an encapsulation process described herein.

The invention provides in another aspect a method of reducing aggregation of capsules described herein containing odourant oil cores, the method comprising the step of converting an odourant ingredient containing aldehyde functionality into a precursor of said ingredient, and encapsulating an oil containing the precursor in a polyurea or polyamide capsule.

In another aspect of the present invention, there is provided a method of reducing aggregation of capsules comprising the step of encapsulating an oil in a capsule as hereinabove defined, the method comprising the step of converting any aldehyde-containing oil core ingredients into a precursor therefor, prior to encapsulation.

In a more particular aspect of the invention, there is provided a method of reducing aggregation of capsules comprising the step of encapsulating an oil, in a capsule as hereinabove defined, the method comprising the step of identifying those ingredients of the oil core ingredients that contain aldehyde functionality, and of those ingredients, converting those having no substituents at the carbon atoms alpha or beta to the aldehyde carbonyl carbon atom into the corresponding precursor prior to encapsulation.

The capsules may be prepared by any method known in the art for producing capsules by interfacial polyaddition of an amine with a suitable co-reactant to form a capsule wall of polymeric material containing recurring nitrogen to carbonyl carbon bonds. As stated hereinabove, suitable co-reactants include isocyanates, acid anhydrides or acyl halides.

By way of example, polyurea capsules can be prepared according to the following general procedure: An aqueous phase may be prepared of water to which a surfactant and/or a protective colloid such as those indicated below have been added. This phase may be stirred vigorously for a time period of only a few seconds up to a few minutes. A hydrophobic phase may then be added. The hydrophobic phase will contain an odourant oil to be encapsulated including one or more precursors, and an isocyanate. The hydrophobic phase may also include suitable solvents. After a period of vigorous stirring, an emulsion is obtained. The rate of stirring may be adjusted to influence the size of droplets of hydrophobic phase in the aqueous phase.

An aqueous solution containing the amine is then added to affect the polyaddition reaction. The amount of amine which is introduced is usually in excess, relative to the stoichiometric amount needed to convert the free isocyanate groups into urea groups.

The polyaddition reaction may take place generally at a temperature ranging from approximately 0 to 100 degrees centrigrade for a period of time ranging from a few minutes to several hours.

The skilled person will appreciate that polyamides may be formed in a similar manner by replacing the isocyanate with a suitable co-reactant for the amine such as an acyl chloride or an acid anhydride.

Conditions for creating capsules by interfacial polyaddition are well known in the art and no further general discussion is needed here. Specific description relating to the preparation of the capsules is provided in the examples below.

Amines useful in the formation of capsules include those compounds containing one or more primary or secondary amine groups which can react with isocyanates or acyl halides to form polyurea or polyamide bonds respectively. When the amine contains only one amino group, the compound will contain one or more additional functional groups that would form a network through a polymerisation reaction.

Examples of suitable amines include 1,2-ethylenediamine, 1,3-diaminopropane, 1,4-diaminobutane, 1,6-diaminohexane, hydrazine, 1,4-diaminocyclohexane and 1,3-diamino-1-methylpropane, diethylenetriamine, triethylenetetramine and bis(2-methylaminoethyl)methylamine.

Other useful amines include poly ethyleneamine (CH2CH2NH)n such as ethyleneamine, diethyleneamine, ethylene diamine, triethylenetetramine, tetraethylenepentamine; poly vinylamine (CH2CHNH2)n sold by BASF (Lupamine different grades); poly ethyleneimine (CH2CH2N)x-(CH2CH2NH)y-(CH2CH2NH2)z sold by BASF under Lupasol grades; poly etheramine (Jeffamine from Huntsman); guanidine, guanidine salt, melamine, hydrazine and urea.

A particularly preferred amine is a polyethyleneimine (PEI), more particularly a PEI from the Lupasol range supplied by BASF, still more particularly Lupasol PR8515.

Isocyanates useful in the formation of polyurea microcapsules include di- and tri-functionalised isocyanates such as 1,6-diisocyanatohexane, 1,5-diisocyanato-2-methylpentane, 1,5-diisocyanato-3-methylpentane, 1,4-diisocyanato-2,3-dimethylbutane, 2-ethyl-1,4-diisocyanatobutane, 1,5-diisocyanatopentane, 1,4-diisocyanatobutane, 1,3-diisocyanatopropane, 1,10-diisocyanatodecane, 1,2-diisocyanatocyclobutane, bis(4-isocyanatocyclohexyl)methane, or 3,3,5-trimethyl-5-isocyanatomethyl-1-isocyanatocyclohexane.

Other useful isocyanates include also the oligomers based on those isocyanate monomers, such as homopolymer of 1,6-diisocyanatohexane. All those monomers and olligomers are sold under the trade name Desmodur by Bayer. Also included are the modified isocyanates and in particular, the waterdispersible isocyanate such as Hydrophilic Aliphatic Polyisocyanate based on Hexamethylene Diisocyanate, (sold under the name BAYHYDUR)

Acyl halides useful in the formation of polyamide microcapsules include di- and tri-functionalised acyl halides, commonly acyl chloride, such as linear halides including malonyl halide, glutarhyl halide, adipoyl halide, pimeloyl halide, sebacoyl halide, or such as cyclic halide including phthaloyl, isophthaloyl or terephthaloyl halide, benzene tricarbonyl trichloride.

Anhydrides useful in the present invention include, but are not limited to, polymers and co-polymers of anhydride-containing compounds, for example styrene maleic anhydride co-polymers, ethylene maleic anhydride co-polymers, octadecene maleic anhydride co-polymers, methyl vinyl ether maleic anhydride co-polymer, isobutylene maleic anhydride co-polymer and maleic anhydride grafted olefin co-polymer.

The classes of protective colloid or emulsifier, which may be employed include maleic-vinyl copolymers such as the copolymers of vinyl ethers with maleic anhydride or acid, sodium lignosulfonates, maleic anhydride/styrene copolymers, ethylene/maleic anhydride copolymers, and copolymers of propylene oxide, ethylenediamine and ethylene oxide, polyvinylpyrrolidone, polyvinyl alcohols, fatty acid esters of polyoxyethylenated sorbitol and sodium dodecylsulfate.

Suitable solvents include aliphatic hydrocarbons, chlorinated aliphatic hydrocarbons, alicyclic hydrocarbons, chlorinated alicyclic hydrocarbons, and aromatic or chlorinated aromatic hydrocarbons. More particularly, solvents include cyclohexane, octadecane, tetrachloroethylene, carbon tetrachloride, xylenes, toluene, chlorobenzene and alkylnaphthalenes.

The capsules can be employed to encapsulate all manner of odourant ingredients that are useful in perfumery applications. Similarly, their odours may also add aroma to foodstuffs beverages and oral care products making them suitable as flavourant ingredients.

Accordingly, in another aspect of the invention there is provided the use of a capsule as described herein in a fragrance or flavour composition.

In yet another aspect of the invention there is provided a flavoured or fragranced article containing capsules described herein or a fragrance or flavour composition containing said capsules.

In another aspect of the invention there is provided a method to confer, enhance, improve or modify the hedonic properties of a perfume composition or of a perfumed article, or a flavour composition or flavoured article, which method comprises adding to said composition or article a capsule as hereinabove described.

The present invention provides in another of its aspects a fragrance or flavour composition comprising a capsule as hereinabove described.

Said fragrance or flavour composition may also comprise carrier materials for the capsules; a perfumery or flavour base; and other adjuvants useful in fragrance and flavour formulations.

The term “carrier materials” as used herein refers to materials that are neutral or practically neutral from a fragrance or flavour point of view, that is, the material does not significantly alter the organoleptic properties of perfuming or flavour ingredients.

As carrier materials one can mention solvents and surfactants. A detailed description of the nature and type of solvents commonly used in perfumery or the flavours industry cannot be exhaustive. However, one can cite as non-limiting examples of solvents useful in perfumery dipropyleneglycol, diethyl phthalate, isopropyl myristate, benzyl benzoate, 2-(2-ethoxyethoxy)-1-ethanol or ethyl citrate.

Carrier materials may also include absorbing gums or polymers.

The term “perfumery or flavour base” as used herein means a composition comprising at least one perfuming or flavourant co-ingredient that is different from the perfume or flavourant contained in the capsules of the present invention.

Moreover, the co-ingredients are used to impart a hedonic effect. For example, such a co-ingredient, if it is to be considered as being a perfuming co-ingredient, must be recognized by a person skilled in the art as being able to impart or modify in a positive or pleasant way the odour of a composition, and not just as having an odour. Similarly, if the co-ingredient is a flavourant it is recognised by a person skilled in the art as being able to create, modify or enhance a flavour accord.

The nature and type of the perfuming or flavourant co-ingredients present in the base do not warrant a more detailed description here, which in any case would not be exhaustive, the skilled person being able to select them on the basis of its general knowledge and according to intended use or application and the desired organoleptic effect.

In general terms, perfuming co-ingredients belong to chemical classes as varied as alcohols, ketones, esters, ethers, acetates, nitriles, terpene hydrocarbons, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that said co-ingredients may also be compounds known to release in a controlled manner various types of perfuming compounds.

Specific examples of flavour co-ingredients may include but are not limited to natural flavors, artificial flavors, spices, seasonings, and the like. Exemplary flavoring co-ingredients include synthetic flavor oils and flavoring aromatics and/or oils, oleoresins, essences, distillates, and extracts derived from plants, leaves, flowers, fruits, and so forth, and a combination comprising at least one of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

Flavour co-ingredients may include aldehydes and esters such as cinnamyl acetate, cinnamaldehyde, citral diethylacetal, dihydrocarvyl acetate, eugenyl 49 formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Generally any flavoring or food additive such as those described in Chemicals Used in Food Processing, publication 1274, pages 63-258, by the National Academy of Sciences, can be used. This publication is incorporated herein by reference.

The term “adjuvant” as used herein means an ingredient that affects the performance of a composition, other than its hedonic performance. For example, an adjuvant may be an ingredient that acts as an aid to processing a composition or an article containing capsules or a flavour or fragrance composition containing capsules, or it may improve handling or storage of said composition or article. It might also be an ingredient that provides additional benefits such as imparting colour or texture to a composition or article. It might also be an ingredient that imparts light resistance or chemical stability to one or more ingredients contained in the composition or article. A detailed description of the nature and type of adjuvant commonly used in perfuming and flavourant compositions cannot be exhaustive, but said ingredients are well known to a person skilled in the art. Examples of adjuvants include solvents and co-solvents; surfactants and emulsifiers; viscosity and rheology modifiers; thickening and gelling agents; preservative materials; pigments, dyestuffs and colouring matters; extenders, fillers and reinforcing agents; stabilisers against the detrimental effects of heat and light, bulking agents, acidulants, buffering agents and antioxidants.

Furthermore, the capsules of the present invention can be used in all the fields of modern perfumery and flavour technology to positively impart or modify the odour of a composition or article into which said capsules are added.

The nature and type of the constituents of a flavoured or perfumed article do not warrant a more detailed description here, which in any case would not be exhaustive, the skilled person being able to select them on the basis of its general knowledge and according to the nature and the desired effect of said article.

Examples of suitable articles include consumer products that may include solid or liquid detergents and fabric softeners as well as all the other articles common in perfumery, namely perfumes, colognes or after-shave lotions, perfumed soaps, shower or bath salts, mousses, oils or gels, hygiene products or hair care products such as shampoos, body-care products, deodorants or antiperspirants, air fresheners and also cosmetic preparations. As detergents there are intended applications such as detergent compositions or cleaning products for washing up or for cleaning various surfaces, e.g. intended for textile, dish or hard-surface treatment, whether they are intended for domestic or industrial use. Other perfumed articles are fabric refreshers, ironing waters, papers, wipes or bleaches.

Consumer products may also include any solid or liquid composition that is consumed for at least one of nourishment and pleasure, or intended to be held in the mouth for a period of time before being discarded. A broad general list includes, but is not limited to, foodstuffs of all kinds, confectionery, baked goods, sweet goods, dairy products and beverages, and oral care products.

The proportions in which the capsules can be incorporated into the various aforementioned articles or compositions vary within a wide range of values. These values are dependent on the nature of the article to be perfumed or flavoured and on the desired organoleptic effect as well as the nature of the co-ingredients in a given base when the capsules are mixed with perfuming or flavourant co-ingredients, solvents or additives commonly used in the art.

For example, in the case of fragrance or flavour compositions, the capsules may be employed in amounts of up to 100% by weight of the compositions. Typically however, the capsules may form between about 0.01 to 100% of the composition, more particularly 0.01% to 10%, still more particularly 0.01 to 1% by weight.

Fragrance or flavour compositions may be employed in articles in widely varying amounts depending on the nature of the article and the particular hedonic effect to be achieved. Typically however, compositions may comprise up to 50% by weight or more of the flavoured or fragranced article, more particularly 0.01 to 50% by weight.

In order to further illustrate the present invention and the advantages thereof, the following specific examples and comparative example are given, it being understood that same are intended only as illustrative and in nowise limitative.

### EXAMPLE 1

### Preparation of Precursor

### Method 1.1

An oil phase was prepared by dividing its composition according to the nature of the raw materials:
phase A: all materials to be used in the oil formation excluding aldehydes
phase B: all aldehydes to be employed in the oil formulation

The precursors were formed by addition of ethyl acetoacetate (1.1 molar equivalent compared to aldehyde) and 2-amino-2-methyl-1-propanol as catalyst (0.1% compared to aldehyde) in the phase B. The solution was then kept for 1 week at 40° C. After this storage, both phases A and B were mixed for further use.

### Method 1.2

The oil phase was not divided according to the nature of the raw materials and the precursors were formed in situ in the total oil phase. 1.1 molar equivalent of ethyl acetate and 0.1% of 2-amino-2-methyl-1-propanol compared to aldehyde content were added. The solution was kept for 1 week at 40° C. prior to encapsulation.

### EXAMPLE 2

### Preparation of Polyamide Capsules

An oil phase was prepared by dissolving isophtahaloyl dichloride (Fluka) in oil (oil composition specified in the examples below) at a level of 10%

An aqueous solution (Solution S1) was prepared by dissolving a polyvinyl alcohol Mowiol 4-88 (Kuru ray) in water at a level of 1%.

An aqueous solution (Solution S2) was prepared when triethylentetraamine (Hunstman) was diluted in water at a level of 3%.

100 g of the oil phase was mixed with 450 g of solution S1 to form an oil-in-water emulsion in a 1 L reactor equipped with a MIG stirrer operating at 1000 rpm. After 5 minutes of mixing, 450 g of solution S2 was slowly added. The resultant slurry of polyamide capsules was kept under stirring for 2 H.

### EXAMPLE 3

### Impact of Aldehyde Presence on Aggregation of Polyamide Capsules

Two capsule populations were formed. A first encapsulating IPM (isopropyl myristate) and a second containing IPM+5% of ethyl vaniline. The capsules were made according to the method of Example 2.

Microscopic examination of the two populations clearly demonstrated that in the population containing the aldehyde (ethyl vaniline) significant aggregation occurred.

### EXAMPLE 4

### Formation of Precursor to Protect Polyamide Capsules from Aggregation

The methodology of Example 2 was applied to encapsulate different perfume oils described as phase A (non aldehyde raw materials) and phase B (aldehyde raw materials).

Phase A ingredients are set forth in Table 1.

The phase B was added at 5% to the phase A prior to encapsulation. Different compositions of phase B have been used corresponding each time to a single aldehyde perfume molecule or to its precursor formed according to the methodology of Method 1.1, above.

TABLE 1
composition of phase A

| | % |
|---|---|
| isocenide | 0.5 |
| florocyclene | 15 |
| herbanate | 1.5 |
| agrumex | 15 |
| isoraldeine 95 | 5 |
| cyclohexyl propionate | 5 |
| allyle | |
| damascone delta | 1 |
| nectaryl | 10 |
| iso E super | 15 |
| brassylate ethylene | 15 |
| cosmone | 1 |
| silvanone | 6 |
| serenolide | 9 |
| ambrofix | 1 |

The results are set forth in Table 2 below. According to the condition of the slurry a scale of aggregation has been defined as follows:

∘ no aggregation of the capsules
+ aggregation of few capsules together only visible under microscopy
++ aggregates of mm size
+++ important aggregation
++++ aggregation is such that a cake is obtained

TABLE 2
polyamide capsules prepared with or without precursor

| | | Water | Encapsulation | |
|---|---|---|---|---|
| | | solubility | No | With |
| Aldehyde used in phase B | | (ppm) | precursor | precursor |
| Linear aldehyde | Aldehyde C10 | 61 | +++ | + |
| | Aldehyde iso C11 | 30 | +++ | + |
| | Aldehyde C12 | 9 | +++ | ∘ |
| | laurique | | | |
| Beta substituted | Lilial | 21 | ++ | ∘ |
| aldehyde | | | | |
| Alpha substituted | Tricyclal | 700 | ++++ | ∘ |
| aldehyde | Aubepine para | 6 | ++ | ∘ |
| | cresol | | | |
| | Aldehyde C12 | 8 | ++ | ∘ |
| | mna | | | |

These trials demonstrate that the solubility in water of the aldehyde can affect, aggregation of the polyamide capsules. Tricyclal is the aldehyde raw material with the highest solubility in water and presents the highest issue with aggregation when used as such. Considering the precursors formed with the linear aldehydes C10 and iso C11, there is still some aggregation when precursors are used but the amount is only very minor and is markedly reduced compared to the free aldehydes.

If we compare the structure of the aldehydes with similar water solubility, we note that the aldehydes presenting the most important aggregation issue are those with no alkyl chain on alpha or beta position to the carbonyl group.

For all the capsules prepared, when an aldehyde precursor is added instead of the aldehyde, the aggregation issue is either avoided altogether or strongly reduced.

### EXAMPLE 5

### Preparation of Polyurea Capsules

### Method 5.1

An oil phase was prepared by adding Desmodur W (Isocyanate from Bayer) to a perfume oil at a level of 16.6%.

An aqueous phase (solution S1) was prepared by adding Luviskol k90 (BASF) to water, at a level of 4.5%. The pH of the solution was adjusted to 11.5 by addition of NaOH at 10%.

An aqueous phase (Solution S2) was prepared when Lupasol PR8515 (BASF) was added to water, at a level of 10%.

300 g of the oil phase was mixed with 500 g of solution S1, to form an oil-in-water emulsion, in a 1 L reactor equipped with a MIG stirrer operating at 1000 rpm.

After 30 minutes of mixing, 200 g of solution S2 was added over a period of 1 minute.

After 30 minutes, the slurry was heated up to 70° C. (1 H), then kept for 2 H at 70° C., then heated to 80° C. and kept for 1 H at 80° C., then heated to 85° C. and kept for 1 H at 85° C., then cooled to 70° C. and kept for 1 H at 70° C. before final cooling at 25° C.

### Method 5.2

An oil phase was prepared when Desmodur W (Bayer) was added in perfume oil at a level of 16.6%.

An aqueous phase (Solution S1) was prepared by adding Luviskol k90 (BASF) to water, at a level of 4.5%. The pH of the solution was adjusted at 10 by addition of a buffer pH=10 at 0.5%.

An aqueous phase (Solution S2) was prepared by adding Lupasol PR8515 (BASF) to water, at a level of 10%.

Capsules were prepared by a similar procedure to that described in 5.1 above

### Method 5.3

An oil phase was prepared when Desmodur W (Bayer) was added in perfume oil at a level of 16.6%.

An aqueous phase (Solution 51) was prepared by adding Luviskol k90 (BASF) to water, at a level of 4.5%. The pH of the solution was adjusted at 11.5 by addition of NaOH at 10%.

An aqueous phase (Solution S2) was prepared by adding Lupamine 1595 (BASF) to water, at a level of 10%.

Capsules were prepared by a similar procedure to that described in 5.1 above

### Method 5.4

An oil phase was prepared when Desmodur W (Bayer) was added in perfume oil at a level of 16.6%.

An aqueous phase (Solution S1) was prepared when Mowiol 40-88 (Kururay) was added in water, at a level of 4.5%.

An aqueous phase (Solution S2) was prepared when Lupasol PR8515 (BASF) was added in water, at a level of 10%.

240 g of oil phase was mixed with 640 g of solution S1, to form an oil-in-water emulsion, in a 1 L reactor equipped with a mig operating at 1000 rpm.

After 30 min, the slurry is heated up to 50° C. and the solution S2 is slowly added (1 H).

The slurry is then heated up to 70° C. and kept for 2 H at 70° C., then heated to 80° C. and kept for 1 H at 80° C., then heated to 85° C. and kept for 1 H at 85° C., then cooled to 70° C. and kept for 1 H at 70° C. before final cooling at 25° C.

### Method 5.5

An oil phase was prepared when Desmodur W and Desmodur N3300 (Bayer) were added in perfume oil at a level of 2.2% and 13% respectively.

An aqueous phase (Solution S1) was prepared when Gantrez AN119 (ISP) was added to water, at a level of 1.6%. The solution was heated at 70° C. for 10 min to disperse the polymer.

An aqueous phase (Solution S2) was prepared when Ethylene diamine (Merck) was added to water, at a level of 7.5%.

30 g of the oil phase was mixed with 80 g of solution S1, to form an oil-in-water emulsion, in a 250 mL vessel equipped with a propeller operating at 1000 rpm.

After 10 min of stirring, 20 g of solution S2 was added.

The slurry was stirred for 30 min at room temperature, then heated to 60° C. and stirred for 3 H at 60° C. before cooling.

### Method 5.6

An oil phase was prepared when Desmodur VL R20 (Bayer) was added in perfume oil at a level of 2.5%.

An aqueous phase (Solution S1) was prepared when Mowiol 4-88 (Kururay) was added in water, at a level of 0.1%.

An aqueous phase (Solution S2) was prepared when diethylentriamine (Merck) was added in water, at a level of 2%.

100 g of oil phase was mixed with 250 g of solution S1, to form an oil-in-water emulsion, in a 500 mL vessel equipped with a propeller operating at 1000 rpm.

After 10 min of stirring, 50 g of solution S2 was added.

The slurry was stirred for 4 h at room temperature.

### Method 5.7

An oil phase was prepared when Desmodur N3300 (Bayer) was added in perfume oil at a level of 6.7%.

An aqueous phase (Solution S1) was prepared when_Mowiol 4-88 (Kururay) was added in water, at a level of 1.1%.

An aqueous phase (Solution S2) was prepared when Hydrosil 1151 (Evonik) was added in water, at a level of 75%.

134 g of oil phase was mixed with 440 g of solution 51, to form an oil-in-water emulsion, in a 1 L vessel equipped with a propeller operating at 1000 rpm.

After 10 min of stirring, 45 g of solution S2 was added.

The slurry was stirred for 2 h at room temperature, then the temperature was slowly increased up to 40° C. (2 h) and the slurry was kept at 40° C. for 2 h more before cooling.

### Method 5.8

An oil phase was prepared when Desmodur W (Bayer) and Bayhydur XP2547 (Bayer) were added in perfume oil at a level of 12.6% and 3.4% respectively.

An aqueous phase (Solution S1) was prepared by adding Luviskol k90 (BASF) to water, at a level of 4.5%. The pH of the solution was adjusted at 10 by addition of a buffer pH=10 at 0.5%.

An aqueous phase (Solution S2) was prepared by adding Lupasol PR8515 (BASF) to water, at a level of 20%.

Capsules were prepared according to the following procedure.

300 g of the oil phase was mixed with 600 g of solution S1, to form an oil-in-water emulsion, in a 1 L reactor equipped with a MIG stirrer operating at 1000 rpm.

After 30 minutes of mixing, 100 g of solution S2 was added over a period of 1 minute.

After 30 minutes, the slurry was heated up to 70° C. (1 H), then kept for 2 H at 70° C., then heated to 80° C. and kept for 1 H at 80° C., then heated to 85° C. and kept for 1 H at 85° C., then cooled to 70° C. and kept for 1 H at 70° C. before final cooling at 25° C.

### Method 5.9

An oil phase was prepared when Desmodur W (Bayer) was added in perfume oil at a level of 13.1%.

An aqueous phase (Solution S1) was prepared by adding Luviskol k90 (BASF) to water, at a level of 4.5%. The pH of the solution was adjusted at 10 by addition of a buffer pH=10 at 0.5%.

An aqueous phase (Solution S2) was prepared by adding Bayhydur XP2547 (Bayer) to water, at a level of 20%.

An aqueous phase (Solution S3) was prepared by adding Lupasol PR8515 (BASF) to water, at a level of 20%.

Capsules were prepared according to the following procedure.

290 g of the oil phase was mixed with 560 g of solution S1, to form an oil-in-water emulsion, in a 1 L reactor equipped with a MIG stirrer operating at 1000 rpm.

After 15 minutes of mixing, 50 g of solution S2 was added over a period of 1 minute. After 30 minutes of mixing, 100 g of solution S3 was added over a period of 1 minute.

After 30 minutes, the slurry was heated up to 70° C. (1 H), then kept for 2 H at 70° C., then heated to 80° C. and kept for 1 H at 80° C., then heated to 85° C. and kept for 1 H at 85° C., then cooled to 70° C. and kept for 1 H at 70° C. before final cooling at 25° C.

### EXAMPLE 6

### Impact of Free Aldehyde on Aggregation of Polyurea Capsules

The Method 5.1 of Example 5 was applied to encapsulate different perfume oils described as phase A (non aldehyde raw materials) and phase B (aldehyde raw materials).

In the following trials, phase A was IPM and phase B was aldehyde perfume molecules. Phase B was added at a level of 5% in phase A.

TABLE 3
polyurea capsules (Method 5.1) prepared with aldehyde

| | | Water | |
|---|---|---|---|
| | | solubility | |
| Aldehyde used in phase B | | (ppm) | Encapsulation |
| Linear aldehyde | Aldehyde C10 | 61 | Aggregation |
| | Aldehyde C12 | 9 | Aggregation |
| | lauric | | |
| Beta substituted | Hydroxycitronellal | 1800 | Aggregation |
| aldehyde | Lilial | 21 | No |
| | | | aggregation |
| Alpha substituted | Tricyclal | 700 | Aggregation |
| aldehyde | Florhydral | 51 | Aggregation |
| | Aldehyde C12 mna | 8 | No |
| | | | aggregation |

The quality of the capsules were examined microscopically for capsules containing IPM solely; IPM+tricyclal; and IPM+Aldehyde C12 nma. In the case of IPM+triplal as encapsulated oil, the capsules appeared aggregated under microscopy.

### EXAMPLE 7

### Protection Against Aggregation of Polyurea Capsules Containing Aldehyde Molecules and Performance Evaluation

The Method 5.1 of Example 5 was applied to encapsulate different perfume oils described as phase A (non aldehyde raw materials) and phase B (aldehyde raw materials).

Phase B contains aldehyde C11 iso or the corresponding precursor prepared according to Method 1.1.

Phase B was added at a level of 5% in phase A.

TABLE 4
Composition of phase A

| | % |
|---|---|
| manzanate | 0.1 |
| estragole | 0.1 |
| galbanum | 0.07 |
| damascone delta | 0.03 |
| ethyl methyl-2-butyrate | 0.3 |
| ebanol | 0.1 |
| Methyl octine carbonate | 0.05 |
| rose oxide | 0.15 |
| yara yara | 1 |
| jasmin | 0.4 |
| hexyl acetate | 2.5 |
| jasmacyclene | 4 |
| salicylate amyle | 5 |
| geraniol intermediate | 6 |
| agrumex | 7.55 |
| hexyl salicylate | 7.55 |
| peonile | 3.5 |
| girofle | 3 |
| galbanone 10 | 1.5 |
| peche pure | 4 |
| rosacetol | 8 |
| isoraldeine 70 | 6 |
| patchouli ess | 2 |
| eucalyptol | 12 |
| tetrahydro linalol | 25 |

TABLE 5
Polyurea capsules prepared with precursor of aldehyde

| Sample | Phase B | Slurry aspect | Performance (Fabcon) |
|---|---|---|---|
| 1 | none | Nice, no | Good - Boost after rubbing |
| | | aggregation | |
| 2 | precursor of | Nice, no | Good - Boost after rubbing |
| | Aldehyde C11 | aggregation | Powerful smell of aldehyde on |
| | iso | | dry |
| 3 | Aldehyde C11 | Cake | N.T. |
| | iso | | |

The capsules prepared with aldehyde C11 iso aggregate whereas those prepared with the precursor of aldehyde C11 iso do not aggregate.

Samples 1 and 2 were used to prepare perfumed fabric conditioners for evaluation of olfactory benefit after washing. The perfumed samples were prepared at a level of 0.5% perfume in a standard fabric conditioner base comprising 13% Quaternium ammonium ARQUAD 2 HT75 from Akzo, 0.3% Silicone Dow Corning DB110 from Dow Corning, 0.6% CaCl2 from Merck and 0.15% Bronidox from Henkel and the washing conditions used were as follow:
total weight of the wash was 2.5 kilos
wash with laundry powder (90 g of standard internal Givaudan laundry powder) done before adding the perfumed fabric conditioner
European machines

For both samples, the encapsulated perfume was recognised on wet and dried towels. After gentle rubbing of the dried towels, a boost of perfume was perceived. In case of sample 2, a powerful smell of aldehyde was recognised on dried towels, proving that the precursor of aldehyde C11 iso releases the aldehyde upon drying.

### EXAMPLE 8

### Protection Against Aggregation of Polyurea Capsules Containing Aldehyde

The Method 5.2 of Example 5 was applied to encapsulate different perfume oils described as phase A (non aldehyde raw materials) and phase B (aldehyde raw materials).

Phase A is similar to the phase A used and described in Table 4 of example 7.

Phase B is set forth below:

| | % |
|---|---|
| Aubepine p cresol | 2.1 |
| Aldehyde iso C11 | 1.67 |
| Lauryl aldehyde C12 | 8.37 |
| Tricyclal | 8.37 |
| Aldehyde C12 mna | 20.92 |
| Lilial | 58.57 |

The capsules obtained with Phase A+Phase B (level of phase B is 20%) were completely aggregated. When the precursors of Phase B obtained according to Method 1.1 were added in Phase A, the capsules obtained were well dispersed.

### EXAMPLE 9

### Protection Against Aggregation of Polyurea Capsules Containing Aldehyde

The Method 5.3 of Example 5 was applied to encapsulate different perfume oils described as phase A (non aldehyde raw materials) and phase B (aldehyde raw materials).

Phase A is similar to the phase A used and described in Table 4 of Example 7.

Phase B is similar to the phase B used and described in the previous Example.

The capsules obtained with Phase A+Phase B (level of phase B is 20%) were completely aggregated. When the precursors of Phase B obtained according to Method 1.1 were added in Phase A, the capsules obtained were well dispersed.

### EXAMPLE 10

### Protection Against Aggregation of Polyurea Capsules Containing Aldehyde

The Method 5.4 of Example 5 was applied to encapsulate different perfume oils described as phase A (non aldehyde raw materials) and phase B (aldehyde raw materials).

Phase A is as described below

Phase B is tricyclal or the precursor of tricyclal obtained according to Method 1.1.

Phase B was added at a level of 4% of aldehyde in phase A.

Composition of phase A used

| | % |
|---|---|
| agrumex | 31.4 |
| Amyl butyrate | 2.62 |
| galbanone | 10.47 |
| Ethyl 2 methyl | 2.62 |
| butyrate | |
| Hexyl acetate | 5.24 |
| nectaryl | 5.24 |
| Peche pure | 10.48 |
| Prenyl acetate | 5.76 |
| Verdyl acetate | 26.17 |

The capsules obtained with Phase A and tricyclal were slightly aggregated, in particular the smaller ones, whereas the capsules obtained with Phase A and the precursor of tricyclal were well dispersed.

### EXAMPLE 11

### Impact of Reactivity and Water Solubility of Aldehyde on Aggregation of Polyurea Capsules

The Method 5.5 of Example 5 was applied to encapsulate different perfume oils described as phase A (non aldehyde raw materials) and phase B (aldehyde raw materials).

The composition of Phase A was described in Table 1 above. Phase B is an aldehyde perfume molecule used as such or as its precursor form prepared according to Method 1.1.

Observations are reported in Table below. According to the aspect of the slurry a scale of aggregation was defined as follow:

∘ no aggregation of the capsules
+ aggregation of few capsules together only visible under microscopy
++ aggregates of mm size
+++ important aggregation
++++ aggregation is such that a cake is obtained

TABLE
polyurea capsules prepared with or without precursor

| | | Water | Encapsulation | |
|---|---|---|---|---|
| | | solubility | No | With |
| Aldehyde used in phase B | | (ppm) | precursor | precursor |
| Linear | Aldehyde C10 | 61 | +++ | ∘ |
| aldehyde | Aldehyde C12 | 9 | ++ | ∘ |
| | laurique | | | |
| Beta ramified | Hydroxycitronellal | 1800 | ++++ | ∘ |
| aldehyde | Lilial | 21 | ∘ | ∘ |
| Alpha ramified | Tricyclal | 700 | ++++ | ∘ |
| aldehyde | Aldehyde C12 mna | 8 | ∘ | ∘ |

Similar conclusions as those reached above can be drawn concerning impact of the reactivity and the solubility of the aldehyde on aggregation of the capsules.

### EXAMPLE 12

### Impact of Reactivity and Water Solubility of Aldehyde on Aggregation of Polyurea Capsules

The Method 5.5 of Example 5 was applied to encapsulate different perfume oils described as phase A (non aldehyde raw materials) and phase B (aldehyde raw materials).

Phase A is similar to the phase A used and described in Table 4 of Example 7.

Phase B is set forth below:

| | % |
|---|---|
| Aubepine p cresol | 2.1 |
| Aldehyde iso C11 | 1.67 |
| Lauryl aldehyde C12 | 8.37 |
| Tricyclal | 8.37 |
| Aldehyde C12 mna | 20.92 |
| Lilial | 58.57 |

Phase B was added at a level of 20% of aldehyde in phase A.

TABLE
Polyurea capsules (Method 5.5) prepared with precursor of aldehyde

| Sample | oil | Comment | Slurry aspect |
|---|---|---|---|
| 1 | Phase A | — | Nice, no |
| | | | aggregation |
| 2 | Phase A + | Both phases mixed for 1H | cake |
| | Phase B | prior to encapsulation | |
| 3 | Phase A + | Precursor prepared | No macroscopic |
| | [phase B]- | according to recipe 1.1 and | aggregation, |
| | precursor | then both phases mixed for | some aggregates |
| | | 1H prior to encapsulation | visible under |
| | | | microscope |

### EXAMPLE 13

### Impact of Reactivity and Water Solubility of Aldehyde on Aggregation of Polyurea Capsules

The Method 5.6 of Example 5 was applied to encapsulate different perfume oils described as phase A (non aldehyde raw materials) and phase B (aldehyde raw materials).

The composition of Phase A is described in Table 1. Phase B is an aldehyde perfume molecule used as such or as its precursor form prepared according to Method 1.1.

Observations are reported in the table, below. According to the aspect of the slurry a scale of aggregation has been defined as follow:

∘ no aggregation of the capsules
+ aggregation of few capsules together only visible under microscopy
++ aggregates of mm size
+++ important aggregation
++++ aggregation is such that a cake is obtained

TABLE
polyurea capsules prepared with or without precursor

| | | | Water | | |
|---|---|---|---|---|---|
| | | | solubility | Encapsulation | |
| sample | Aldehyde used in phase B | | (ppm) | No precursor | With precursor |
| 1 | Linear | Aldehyde C10 | 61 | ++++ | ∘ |
| 2 | aldehyde | Aldehyde C12 laurique | 9 | ++++ | ∘ |
| 3 | | Capronaldehyde | 1700 | ++++ | ∘ |
| | | (hexanal) | | | |
| 4 | | Pino acetaldehyde | 86 | ++++ | ∘ |
| 5 | Beta subd | Lilial | 21 | ∘ | ∘ |
| 6 | aldehyde | Ald C9 isononylic | 160 | +++ | ∘ |
| 7 | | Hydroxycitronellal | 1800 | +++ | ∘ |
| 8 | | Cinnamic ald | 1900 | + | ∘ |
| 9 | | Mefranal | 100 | ∘ | ∘ |
| 10 | Alpha subd | Tricyclal | 700 | +++ | ∘ |
| 11 | aldehyde | Aldehyde C12 mna | 8 | ∘ | ∘ |
| 12 | | Hydratropic ald | 650 | + | + |
| 13 | | Cuminic ald | 280 | ++ | ∘ |
| 14 | | Cyclohexal | 1479 | ∘ | ∘ |
| 15 | | Cyclomyral | 40 | ∘ | ∘ |
| 16 | | Melonal | 344 | ++++ | ∘ |
| 17 | | Hexyl cinnamic ald | 2 | + | ∘ |
| 18 | | Methyl cinnamic ald | 580 | ∘ | ∘ |
| 19 | | Scentenal | 2245 | ++ | ∘ |

Similar conclusions can be drawn as those above concerning impact of the reactivity and the solubility of the aldehyde on aggregation of the capsules.

Some of the preceding capsules were analyzed by SPME in order to control that the aldehyde molecules were properly released once the capsules were dried.

The method used is described below.
A few drops of the slurry were deposited on a paper and allowed to dry for 24 H.
Once dried, the capsules were enclosed in a vial.
The vial was placed in an oven to extract the odorant molecules, which were then analyzed by gas chromatography.
The percentage of aldehyde odorant molecule contained in the extract was determined.

To determine the percentage of aldehyde odorant molecules released after breaking of the capsules, the same method was applied but before depositing the capsules in a vial, the paper surface was scratched to break the capsules.

The results are reported in the table below.

Percentage determined by GC

| sample | Aldehyde detected | before rubbing | after rubbing |
|---|---|---|---|
| 1 | Aldehyde C10 | 1.6 | 2.6 |
| 3 | Hexanal | 0.3 | 1.1 |
| 4 | Pinoacetaldehyde | 1 | 0.7 |
| 6 | Ald C9 isononylic | 3.2 | 3.9 |
| 7 | Hydroxycitronellal | 0.01 | 0.14 |
| 10 | Tricyclal | 5.3 | 7 |
| 13 | Cuminic Aldehyde | 7.7 | 9.6 |
| 16 | Melonal | 2.4 | 6.2 |

These results confirm that the aldehyde precursor releases the aldehyde during drying.

### EXAMPLE 14

### Impact of Reactivity and Water Solubility of Aldehyde on Aggregation of Polyurea Capsules

The Method 5.7 of Example 5 was applied to encapsulate different perfume oils described as phase A (non aldehyde raw materials) and phase B (aldehyde raw materials).

The composition of Phase A is described in Table 1. Phase B is an aldehyde perfume molecule used as such or as its precursor form added at a level of 5% in Phase A.

TABLE
Polyurea capsules (Method 5.7) prepared with precursor of aldehyde

| Phase B | Comment | Slurry aspect |
|---|---|---|
| — | — | Nice, no aggregation |
| Lilial | Both phases mixed for | cake |
| | 1H prior to | |
| | encapsulation | |
| Verdantiol (Lilial | Both phases mixed for | No macroscopic |
| methylanthranilate | 1H prior to | aggregation, some |
| Schiff base) | encapsulation | aggregates visible under |
| | | microscope |
| Knoevenagel | Precursor prepared | cake |
| precursor of Lilial | according to recipe 1.1 | |
| | and then both phases | |
| | mixed for 1H prior to | |
| | encapsulation | |

In this example, for lilial, a Schiff base precursor should be employed.

### EXAMPLE 15

### Impact of Reactivity and Water Solubility of Aldehyde on Aggregation of Polyurea Capsules

The Methods 5.8 and 5.9 of Example 5 were applied to encapsulate different perfume oils described as phase A (non aldehyde raw materials) and phase B (aldehyde raw materials).

Phase A is similar to the phase A used and described in Table 4 of example 7.

Phase B is set forth below:

| | % |
|---|---|
| Aubepine p cresol | 2.1 |
| Aldehyde iso C11 | 1.67 |
| Lauryl aldehyde C12 | 8.37 |
| Tricyclal | 8.37 |
| Aldehyde C12 mna | 20.92 |
| Lilial | 58.57 |

The capsules obtained with Phase A+Phase B (level of phase B is 20%) were completely aggregated, and a cake was formed in the reactor. When the precursors of Phase B obtained according to Method 1.1 were added in Phase A, the capsules obtained were well dispersed.

### EXAMPLE 16

### Olfactory Performance of Polyurea Capsules in Hair Care

Hair Switch testing was carried out using standard hair protocols with a dosage of encapsulated perfume of 0.2%. The capsules characteristics compared in this example are reported in the Table below. They were all prepared according to different recipes but with the same perfume. The perfume composition is given in Table below

| Ingredient | % |
|---|---|
| Agrumex | 30 |
| Amyl Butyrate | 2.5 |
| Galbanone | 10 |
| Ethyl 2-methyl butyrate | 2.5 |
| Hexyl acetate | 5 |
| Nectaryl | 5 |
| Peche Pure | 10 |
| Prenyl acetate | 6 |
| Triplal | 4 |
| Verdyl Acetate | 25 |

### Protocol for Shampoo

Switches used: European hair, virgin, not damaged (but re-used several times)
Dampen switch with warm water and place on weighing balance
Squeeze 2.5 g of shampoo along the switch using a syringe
Massage the shampoo into the hair switch for 30 seconds
Leave the lathered switch to soak for 1 minute before rinsing out under running hand-hot water for approx. 30 seconds
Squeeze the switch between two fingers to remove excess water
Dry switch; either hang up to air dry or immediately blow dry using a hair dryer
Leave air dried samples hanging in an odour free room for 24 hours
Assess each switch before and after combing by use of a ten point scale: 0=No odour, 9=very strong

### Protocol for Hair Conditioner:

The same protocol is followed for conditioner except the hair switches are pre-washed in unfragranced shampoo before the conditioner is applied

| | | Performance in | Performance in |
|---|---|---|---|
| | | shampoo (before/ | conditioner (before/ |
| Sample | Recipe | after combing) | after combing) |
| 1—CGS-A-048 | 5.4 | 1.6/2.3 | 2.1/3.4 |
| 3—CGS-ND-001 | 5.2 | 1.5/1.9 | 1.7/1.9 |
| 4—CGS-ND-007 | 5.8 | 2.2/3.9 | 3.8/6.1 |

1. A capsule comprising an odourant oil core surrounded by polymeric capsule wall, the capsule wall being formed of a polymer containing recurring nitrogen to carbonyl carbon bonds wherein the oil core contains an aldehyde precursor.

2. A capsule according to claim 1 wherein the capsule wall is a polyurea.

3. A capsule according to claim 1 wherein the capsule wall is a polyamide.

4. A capsule according to claim 1, wherein the precursor is a precursor of an aldehyde having no substituents at the carbon atoms alpha or beta to the aldehyde carbonyl carbon atom.

5. A capsule according to claim 1, wherein the oil core contains an aldehyde precursor of an aldehyde which has no substituents at the carbon atoms alpha or beta to the aldehyde carbonyl carbon atom, and a perfume ingredient, which has free aldehyde functionality, which ingredient is an aldehyde substituted at the carbon atom alpha or the beta to the aldehyde carbonyl carbon atom.

6. A capsule according to claim 1, wherein the aldehyde in the form of the precursor is selected from the group consisting of phenylacetaldehyde, p-methyl phenylacetaldehyde, p-isopropyl phenylacetaldehyde, methylnonyl acetaldehyde, phenylpropanal, 3-(4-t-butylphenyl)-2-methyl propanal, 3-(4-t-butylphenyl)-propanal, 3-(4-methoxyphenyl)-2-methylpropanal, 3-(4-isopropylphenyl)-2-methylpropanal, 3-(3,4-methylenedioxyphenyl)-2-methylpropanal, 3-(4-ethylphenyl)-2,2-dimethylpropanal, phenylbutanal, 3-methyl-5-phenylpentanal, hexanal, trans-2-hexenal, cis-hex-3-enal, heptanal, cis-4-heptenal, 2-ethyl-2-heptenal, 2,6-dimethyl-5-heptenal (melonal), 2,6-dimethylpropanal, 2,4-heptadienal, octanal, 2-octenal, 3,7-dimethyloctanal, 3,7-dimethyl-2,6-octadien-1-al, 3,7-dimethyl-1,6-octadien-3-al, 3,7-dimethyl-6-octenal, 3,7-dimethyl-7-hydroxyoctan-1-al, nonanal, 6-nonenal, 2,4-nonadienal, 2,6-nonadienal, decanal, 2-methyl decanal, 4-decenal, 9-decenal, 2,4-decadienal, undecanal, 2-methyldecanal, 2-methylundecanal, 2,6,10-trimethyl-9-undecenal, undec-10-enyl aldehyde, undec-8-enanal, dodecanal, tridecanal, tetradecanal, anisaldehyde, bourgenonal, cinnamic aldehyde, [alpha]-amylcinnam-aldehyde, [alpha]-hexyl cinnamaldehyde, methoxy cinnamaldehyde, citronellal, hydroxy-citronellal, isocyclocitral, citronellyl oxyacet-aldehyde, cortexaldehyde, cumminic aldehyde, cyclamem aldehyde, florhydral, heliotropin, hydrotropic aldehyde, lilial, vanillin, ethyl vanillin, benzaldehyde, p-methyl benzaldehyde, 3,4-dimethoxybenzaldehyde, 3- and 4-(4-hydroxy-4-methyl-pentyl)-3-cyclohexene-1-caroxaldehyde, 2,4-dimethyl-3-cyclohexene-1-carboxaldehyde, 1-methyl-3-4-methylpentyl-3-cyclohexencarboxaldehyde, and p-methylphenoxyacetaldehyde.

7. A capsule according to claim 1 wherein the precursor is product of the reaction of a beta-keto ester and an aldehyde.

8. A capsule according to claim 7 wherein the beta-keto ester is selected from the group consisting of allyl acetoacetate, methyl acetoacetate, ethyl acetoacetate acetoacetic n-propyl ester, ethyl propionyl acetate, diallyl malonate, or diethyl, dipropyl or dibutyl malonates.

9. A capsule according to claim 1 wherein the precursor is a Schiff base of an aldehyde.

10. A method of forming a capsule according to claim 1, the method comprising the step of: by forming a polymeric wall around an oil core by the polyaddition of an amine with a co-reactant such that the polymeric wall comprises a polymer containing recurring nitrogen to carbonyl carbon bonds, by converting aldehyde-containing oil core ingredients into a precursor therefor, prior to the step of encapsulating the oil core in the polymeric wall.

11. A method according to claim 10, said method comprising the step of: identifying those ingredients forming the oil core that contain aldehyde functionality, and of those ingredients, converting those having no substituents at the carbon atoms alpha or beta to the aldehyde carbonyl carbon atom into the corresponding precursor prior to encapsulation.

12. A method according to claim 10 wherein the co-reactant is an acyl halide, an acid anhydride or an isocyanate.

13. A method of forming a capsule according to claim 10 comprising the steps of:—
I) forming a precursor of an aldehyde
II) forming an oil phase containing said precursor and a co-reactant for the an amine;
III) emulsifying the oil phase with an aqueous phase optionally containing a surfactant, a protective colloid or both, to form droplets of oil in an aqueous continuous phase;
IV) adding an amine to effect capsule wall formation around the oil droplets by the interfacial reaction of the amine with the co-reactant in the oil phase.

14. A method of reducing aggregation of a plurality of capsules of claim 1 comprising the step of encapsulating an oil in a capsule, by converting any aldehyde-containing oil core ingredients into a precursor therefor, prior to encapsulation.

15. A method according to claim 13 the method comprising the step of identifying those ingredients of the oil core ingredients that contain aldehyde functionality, and of those ingredients, converting those having no substituents at the carbon atoms alpha or beta to the aldehyde carbonyl carbon atom into the corresponding precursor prior to encapsulation.

16. A perfumed article comprising capsules according to claim 1.

17. A perfumed article according to claim 16 selected from the group consisting of solid or liquid detergents and fabric softeners, perfumes, colognes or after-shave lotions, perfumed soaps, shower or bath salts, mousses, oils or gels, hygiene products, hair care products, shampoos, body-care products, deodorants or antiperspirants, air fresheners and cosmetic preparations.
